(19) United States
(12) Patent Application Publication
(10) Pub. No.: US 2026/0295703 A1
(43) Pub. Date: Oct. 1, 2026

(54) METHOD FOR JOINING DISSIMILAR MATERIALS OF TITANIUM METAL AND SOLDER FOR VACUUM VESSEL SEALING

(71) Applicant: SHIJIAZHUANG TIEDAO UNIVERSITY, Shijiazhuang, Hebei (CN)

(72) Inventors: Lianhai HU, Shijiazhuang (CN); Lixiang LU, Shijiazhuang (CN); Songtao WANG, Shijiazhuang (CN); Yongfu CHEN, Shijiazhuang (CN); Shiqing MA, Shijiazhuang (CN); Yanan GAO, Shijiazhuang (CN); Deli SANG, Shijiazhuang (CN); Jie HU, Shijiazhuang (CN); Changling XU, Shijiazhuang (CN); Shuai ZHANG, Shijiazhuang (CN); Zhenyang WANG, Shijiazhuang (CN); Mengqiu OU YANG, Shijiazhuang (CN); Jie LIU, Shijiazhuang (CN); Yueqiang FENG, Shijiazhuang (CN); Junrong WANG, Shijiazhuang (CN); Fengjiao HAN, Shijiazhuang (CN); Shoulong ZHAO, Shijiazhuang (CN)

(73) Assignee: SHIJIAZHUANG TIEDAO UNIVERSITY, Shijiazhuang, Hebei (CN)

(21) Appl. No.: 19/145,721

(22) PCT Filed: Nov. 4, 2024
(86) PCT No.: PCT/CN2024/129548

§ 371 Date: Jul. 3, 2025

(30) Foreign Application Priority Data
Dec. 25, 2023 (CN) 202311792427.5

(51) Int. Cl. B23K 1/008; B23K 1/20; B23K 9/24; B23K 35/02; B23K 35/32; B23K 35/36; B23K 103/18; C23C 4/08; C23C 4/134

(52) U.S. Cl. CPC B23K 1/008; B23K 1/206; B23K 9/24; B23K 35/0261; B23K 35/325; B23K 35/3602; B23K 35/3607; C23C 4/08; C23C 4/134; B23K 2103/18

(57) ABSTRACT

Provided is a method for joining dissimilar materials of a titanium metal and a solder for vacuum vessel sealing. The method includes: first, designing and preparing a metal transition section; second, designing and preparing a cladding material; third, selecting a cladding heat source and a cladding process, and performing cladding to prepare a bimetallic layer; fourth, stamping and hole-making the bimetallic layer to prepare a stamped bimetallic structural part; fifth, selecting a joining heat source and a joining process, and performing joining to prepare a dissimilar material structural component for vacuum sealing; sixth, preparing an integral vessel by welding; and seventh, starting a vacuum furnace to perform vacuum sealing, thereby preparing a vacuum vessel.

### CROSS REFERENCE TO RELATED APPLICATION

This patent application is a national stage application of International Patent Application No. PCT/CN2024/129548, filed on Nov. 4, 2024, which claims the priority of Chinese Patent Application No. 202311792427.5, filed with the China National Intellectual Property Administration on Dec. 25, 2023, and entitled “Method for joining dissimilar materials of titanium metal and solder for vacuum vessel sealing”. The disclosure of the two applications is incorporated by reference in its entirety.

### TECHNICAL FIELD

The present disclosure belongs to the technical field of welding, and in particular to a method for joining dissimilar materials of a titanium metal and a solder for vacuum vessel sealing.

### BACKGROUND

Vacuum vessels include vacuum cups (bottles, pots), vacuum pressure pots, vacuum lunch boxes, vacuum thermal cookers, vacuum members, and other products with vacuum layer structures, which have been widely used in both production and daily life due to their versatility. A vacuum cup (bottle, pot) is a vacuum-insulated vessel which is designed for storing hot or cold water, beverages, and other liquids, featuring thermal insulation function. A vacuum pressure pot is a vacuum-insulated vessel which is designed for storing hot or cold water, featuring an air pressure-driven water discharge function. A vacuum lunch box is a vacuum-insulated vessel which is designed for storing meals, dishes, soups, and other foods, and may include an inner vessel. A vacuum thermal cooker is a vacuum-insulated vessel which is designed for simmering food, with an inner pot that can be removed for heating. A vacuum member refers to a non-independent vacuum structure part in daily utensils that come into contact with the food, typically composed of an inner liner, an outer shell, etc.

Existing vacuum vessels are predominantly made of stainless steel. However, stainless steel vacuum vessels have significant drawbacks. Firstly, the stainless steel typically contains heavy metal elements such as nickel, chromium, manganese, cadmium, lead, etc. When the vacuum vessel is used to store acidic or salty liquids like fruit juices or soups, these heavy elements will be released from the stainless steel, which not only cause the beverages to lose their taste and deteriorate, but also allows the heavy metals to enter the human body upon consumption, posing serious health risks with long-term use, Secondly, liquids with acidic or alkaline properties are prone to corroding stainless steel, leading to a shortened service life of the vacuum vessel. In addition, the high density of the stainless steel results in a high mass of the vacuum vessel, making it inconvenient to carry during outdoor activities. These factors greatly limit the applicability of the stainless steel vacuum vessel.

Currently, vacuum vessels primarily made of titanium metal can effectively overcome the drawbacks of stainless steel vessels. Firstly, titanium is chemically stable and can react with oxygen at room temperature to form an extremely thin and dense oxide layer. This oxide layer offers far superior corrosion resistance compared to stainless steel, making titanium vessels suitable for storing carbonated drinks, tea, fruit juice, and even traditional Chinese medicine in daily life, with minimal risk of heavy metal leaching. Secondly, titanium is human-friendly and exhibits “bio-friendly” properties. Furthermore, titanium metal is characterized by high strength and low density, which is approximately 43% lighter than stainless steel of the same volume, making the vacuum vessel durable and easy to carry. Finally, titanium metal is highly corrosion-resistant and has long service life.

However, vacuum sealing of titanium metal vessels is challenging. Currently, there are two main methods employed, one method involves using direct scaling, where a vacuum hole is formed in the bottom of the vessel, which is then sealed using solder after vacuumizing. There are two categories of solders, one is metal solder (metal brazing filler), such as Ag—Cu—Ti alloys. The metal solder is melted to form liquid metal, which wets the metal surface to achieve brazing. The other is oxide solder (oxide brazing filler), which belongs to inorganic solder. The oxide solder is melted to form glass phase, which wets the metal surface to achieve brazing. However, when these two solders (brazing fillers) are used for titanium metal sealing, poor chemical compatibility, significant difference in physical properties, and poor wettability between the solder and the titanium metal lead to low bonding strength, poor impact resistance and sealing effect, and easy cracking on the titanium alloy, which makes the vacuum vessel unable to maintain a vacuum state for a long time, resulting in poor thermal insulation and a short lifespan. The other method involves using indirect sealing, where stainless steel is used as a transition material. The stainless steel is brazed with the titanium alloy, and then the stainless steel and the solder are subjected to vacuum sealing. Such an indirect joining method can improve the sealing performance to a certain extent. However, the need for two brazing processes makes it difficult to increase the temperature of the second brazing, leading to the failure of high-temperature vacuumizing. If the brazing temperature is increased, the brazing effect between the stainless steel and the titanium alloy will be compromised, causing stress and deformation at the joint of the stainless steel and the titanium alloy, reducing bonding strength and scaling performance, and even leading to cracking. Therefore, this indirect method cannot achieve high-temperature sealing. The higher the sealing temperature, the higher the degree of vacuum required for the fabricated vacuum vessel, making it more difficult to meet vacuum requirements. Additionally, the two brazing processes result in low brazing efficiency, high cost, and a complex process. Finally, the combined brazing joint exhibits poor impact resistance, poor sealing performance, short vacuum maintenance time, poor thermal insulation efficiency, and a short service life.

In conclusion, how to efficiently achieve large-scale dissimilar material joining of titanium metal and solder to reduce cost, how to minimize the significant stress and deformation caused by large differences in physical properties between titanium metal and solder, how to improve the low bonding strength of the joint, poor impact resistance, inadequate thermal insulation performanc, poor sealing performance, and short service life caused by poor chemical compatibility and poor wettability between titanium metal and solder, are key industrial problems needing to be addressed at present. To solve these dissimilar material joining problems, it is necessary to develop a new joining method, process, and material to create innovative technologies for joining titanium metal and solder.

### SUMMARY

To solve the problems associated with the joining of dissimilar materials of titanium metal and solder for vacuum vessel sealing, including complex joining process, low efficiency, high cost, the tendency to form brittle structures, large stress and deformation, susceptibility to cracking and joining defects, low bonding strength, poor impact resistance, inadequate thermal insulation, poor sealing, short service life, and difficulty in achieving high-temperature brazing, the present disclosure provides a method for joining dissimilar materials of a titanium metal and a solder for vacuum vessel sealing.

To achieve the object above, the present disclosure provides the following technical solutions:

Provided is a method for joining dissimilar materials of a titanium metal and a solder for vacuum vessel sealing, including the following steps:
1) designing and preparing a metal transition section 1 according to composition, physical and chemical properties of a titanium metal 4 to be joined, where the metal transition section 1 is required to exhibit good chemical compatibility with the titanium metal 4;
2) designing and preparing a cladding material R according to compositions, physical and chemical properties of the metal transition section 1 and a solder D, where the cladding material R is required to exhibit good plasticity, as well as good chemical compatibility with the metal transition section 1 and good wettability with the solder D;
3) selecting a cladding heat source and determining a cladding process corresponding to the cladding heat source, setting process parameters for the cladding heat source, starting a first heat source device, and locally cladding a surface of the metal transition section 1 by using the cladding material R to prepare a cladding layer 2, thereby forming a bimetallic layer L composed of the cladding layer 2 and the metal transition section 1;
4) polishing a surface of the cladding layer 2, and stamping the bimetallic layer L from one surface of the cladding layer 2 by using a stamping device, to make the bimetallic layer L form a depression as well as a stamped hole 3 at a center, thus preparing a stamped bimetallic structural part W;
5) selecting a joining heat source and determining a joining process corresponding to the joining heat source, setting process parameters for the joining heat source, starting a second heat source device, and joining the titanium metal 4 and the metal transition section 1 in the stamped bimetallic structural part W to prepare a dissimilar material structural component S for vacuum sealing;
6) joining the dissimilar material structural component S for vacuum sealing with other parts of a vessel by welding to form a vessel V; and
7) placing the solder D at the stamped hole 3 formed by stamping the bimetallic layer of the vessel V, then placing the vessel V in a vacuum furnace, setting process parameters, and starting the vacuum furnace to perform vacuum sealing between the solder D and the vessel V, thereby preparing a vacuum vessel.

An indirect joining method is adopted to achieve the joining between the titanium metal and the solder. At first, the metal transition section is designed and prepared, and various cladding processes are used to perform local cladding on the metal transition section to prepare the bimetallic layer. Secondly, the bimetallic layer is stamped by using a stamping device to prepare a stamped bimetallic structural part with a vacuumizing hole. Thirdly, by adding or not adding welding wire, various welding methods are employed to achieve fusion joining between the titanium metal and the metal transition section of the stamped bimetallic structural part. Finally, the brazing joining between the solder and the cladding layer is performed by using a vacuum furnace device. According to the present disclosure, an additive manufacturing technology (surface modification technology), a dissimilar metal joining technology, and a dissimilar material brazing technology are combined to form a novel dissimilar material joining technology, thus preparing a titanium metal-metal transition layer-cladding layer-solder joining structure. The combined joining method is simple in process, low in cost, high in joining efficiency, good in quality of the combined joint, and high in comprehensive performance.

The method for joining dissimilar materials of the titanium metal and the solder for vacuum vessel sealing adopts the following basic principle:

First, a metal transition section 1 is designed according to composition, physical and chemical properties of the titanium metal 4 to be joined, where the metal transition section 1 is required to exhibit good chemical compatibility with the titanium metal 4. If a welding wire H is used for joining the titanium metal 4 and the metal transition section 1, the welding wire H is required to exhibit good chemical compatibility with both the titanium metal 4 and the metal transition section 1. Due to the significant differences in thermal physical properties such as the coefficient of thermal expansion between the titanium metal 4 and the solder D, as well as poor chemical compatibility and wettability, direct brazing between the titanium metal 4 and the solder D would result in low bonding strength, high joining stress, poor performance, and susceptibility to cracking. Therefore, it is necessary to use the metal transition section 1 for indirect joining. If no welding material is added, the formation of brittle structures such as intermetallic compounds at the joint between the titanium metal 4 and the metal transition section 1 can be avoided due to good chemical compatibility between the metal transition section 1 and the titanium metal 4. If the welding wire H is used, due to good chemical compatibility between any two of the titanium metal 4, the metal transition section 1, and the welding wire H, brittle structures, which could degrade weld performance or even cause cracking, is prevented from forming at the joint of the titanium metal 4 and the metal transition section 1.

Second, a cladding material R is designed according to the compositions, physical and chemical properties of the metal transition section 1 and the solder D, where the cladding material R is required to exhibit good plasticity, as well as good chemical compatibility with the metal transition section 1 and good wettability with the solder D. Due to the significant difference in physical properties, poor chemical compatibility, and poor wettability between the metal transition section 1 and the solder D, the metal transition section 1 and the solder D cannot be directly joined, it is required to clad a local area of the metal transition section 1, and the metal transition section 1 can be joined with the solder after the cladding layer 2 is prepared. Firstly, since the cladding material R has good plasticity and low yield strength, and the prepared cladding layer 2 exhibits good plasticity and ductility, which allows the cladding layer 2 to deform under low stress. Additionally, since the plasticity deformation temperature of the cladding layer 2 is close to the softening temperature of the solder, the stress during brazing of the cladding layer 2 and the solder D can be significantly reduced, thus avoiding cracking. Secondly, since the cladding material R has good chemical compatibility with the metal transition section 1, enabling the cladding layer 2 to achieve good metallurgical bonding with the base layer of the metal transition section 1 without forming brittle structures such as intermetallic compounds, thereby avoiding cracking. Thirdly, since the cladding material R has good wettability with the solder D, which allows the solder D to spread well on the cladding layer 2 after melting, achieving strong brazing bonding between the cladding layer 2 and the solder D. Finally, since the cladding material R has good plasticity, and the prepared cladding layer 2 exhibits excellent plasticity and ductility. Combined with the moderate plasticity and strength of the metal transition section 1, the prepared bimetallic layer has excellent comprehensive mechanical properties and excellent stamping performance. This satisfies the requirements of the subsequent stamping process and ensures accurate stamping shape during stamping.

Third, an appropriate cladding heat source is selected, and a cladding process corresponding to the cladding heat source is determined, and a surface of the metal transition section 1 is locally clad by using the cladding material R. A consumable electrode are heat source, a non-consumable electrode arc heat source, a plasma arc heat source, a laser heat source, or a laser-arc hybrid heat source and the cladding process corresponding to the cladding heat source are used for cladding. Due to good chemical compatibility between the metal transition section 1 and the cladding material R, i.e., the metallurgic compatibility is good, the formation of brittle structures and cracks can be avoided, High-quality cladding can be achieved by employing an appropriate cladding process and a matched cladding material R.

Fourth, a stamped bimetallic structural part is prepared by using a stamping device. A surface of the cladding layer 2 is polished, and the bimetallic layer is stamped from one surface of the cladding layer 2 by using the stamping device. Due to the good plasticity of the cladding layer and the good strength and plasticity of the metal transition section serving as the base layer, the prepared bimetallic layer exhibits moderate plasticity and strength, along with excellent comprehensive performance, which can meet the requirements for the stamping process. After stamping, the bimetallic layer forms a depression and a stamped hole 3 at a center, i.e., a vacuumizing hole, thus preparing the stamped bimetallic structural part.

Fifth, an appropriate joining heat source is selected, and a joining process corresponding to the joining heat source is determined to join the titanium metal 4 with the metal transition section 1 in the stamped bimetallic structural part W, thereby preparing a dissimilar material structural component S for vacuum sealing. A consumable electrode are heat source, a non-consumable electrode arc heat source, a plasma are heat source, an electron beam heat source, a laser heat source, or a laser-arc hybrid heat source and the joining process corresponding to the joining heat source are used for joining to achieve fusion welding. Since the metal transition section 1 exhibits good compatibility with the titanium metal 4, i.e., the welding performance is good, if the welding wire H is added, the welding wire H exhibits good chemical compatibility with both the titanium metal 4 and the metal transition section 1, high-quality dissimilar metal joining can be achieved by adding welding wire or not adding welding wire by adopting an appropriate joining process, the formation of brittle structures and weld cracking can be avoided, and the joint exhibits good comprehensive performance.

Sixth, the dissimilar material structural component S is joined with other parts of a vessel by welding to form a vessel V, which is then used for vacuum sealing in the next step.

Seventh, vacuum sealing between the dissimilar materials is performed on the solder D and the cladding layer of the stamped bimetallic structural part of the vessel V. The solder D is placed at the stamped hole formed by stamping the bimetallic layer of the vessel V, then the vessel V is placed in a vacuum furnace. Process parameters are set, the vacuum furnace is started, and the vacuum furnace is vacuumized. When the vacuum sealing temperature is reached, thermal insulation is conducted until the solder D is completely melted and the stamped hole is completely blocked, and then cooling is conducted to complete the vacuum sealing for a vessel. On the one hand, due to the good wettability of the solder D with the cladding layer 2 prepared by using the cladding material R, the solder D can be well spread on the cladding layer 2 after melting, improving the bonding strength. On the other hand, a certain residual stress will be generated due to the difference in the coefficients of linear expansion between the cladding layer 2 and the solder D. However, the cladding layer has good plasticity and ductility, and low yield strength. Additionally, the plastic deformation temperature of the cladding layer 2 is close to the softening temperature of the solder D. As a result, the cladding layer 2 deforms under low stress during brazing, significantly reducing, even eliminating, the residual stress, making the bonding strength between the solder D and the cladding layer 2 high, and avoiding cracking.

The present disclosure further provides a dissimilar material structural component for vacuum sealing, being formed by joining a stamped bimetallic structural part W and a titanium metal 4; where
the stamped bimetallic structural part W is formed by stamping a bimetallic layer L, the stamping includes stamping from one surface of a cladding layer 2 of the bimetallic layer L to make the bimetallic layer L form a depression as well as a stamped hole 3 at a center;
the bimetallic layer L is composed of the cladding layer 2 and a metal transition section 1, and the cladding layer 2 is prepared by locally cladding a surface of the metal transition section 1 by using a cladding material R;
a material for the metal transition section 1 exhibits good chemical compatibility with that of the titanium metal 4;
a material for the cladding layer 2 exhibits good plasticity, and good chemical compatibility with that of the metal transition section 1.

In some embodiments, the joining is conducted by using a butt joint or a lap joint;
under a condition that the joining is conducted by using the butt joint, a butt weld 5 is further included between the titanium metal 4 and an outer edge.
under a condition that the joining is conducted by using the lap joint, a lap weld 6 is further included between the titanium metal 4 and an outer edge.

The present disclosure further provides a method for preparing the dissimilar material structural component as described in the above technical solution, including the following steps:
1) designing and preparing the metal transition section 1 according to composition, physical and chemical properties of the titanium metal 4 to be joined, where the metal transition section 1 is required to exhibit good chemical compatibility with the titanium metal 4;
2) designing and preparing the cladding material R according to compositions, physical and chemical properties of the metal transition section 1 and a solder D, where the cladding material R is required to exhibit good plasticity, as well as good chemical compatibility with the metal transition section 1 and good wettability with the solder D;
3) selecting a cladding heat source and determining a cladding process corresponding to the cladding heat source, setting process parameters for the cladding beat source, starting a first heat source device, and locally cladding a surface of the metal transition section 1 by using the cladding material R to prepare the cladding layer 2, thereby forming the bimetallic layer L composed of the cladding layer 2 and the metal transition section 1;
4) polishing a surface of the cladding layer 2, and stamping the bimetallic layer L from one surface of the cladding layer 2 by using a stamping device, to make the bimetallic layer L form a depression as well as a stamped hole 3 at a center, thus preparing the stamped bimetallic structural part W; and
5) selecting a joining heat source and determining a joining process corresponding to the joining heat source, setting process parameters for the joining heat source, starting a second heat source device, and joining the titanium metal 4 and the metal transition section 1 in the stamped bimetallic structural part W to prepare the dissimilar material structural component for vacuum scaling.

Compared with the prior art, the joining problems caused by poor chemical compatibility, significant differences in physical properties, and poor wettability between the titanium metal and the solder, can be solved by organically combining an additive manufacturing technology (surface modification technology), a dissimilar metal joining technology, and a dissimilar material brazing technology. The method for joining dissimilar materials of the titanium metal and the solder for vacuum vessel sealing, provided by some embodiments of the present disclosure, has the beneficial effects of low joining cost, simple joining process, high joining efficiency, good joining flexibility, and small stress and deformation, which can prevent grain coarsening in the heat-affected zone, avoid the formation of brittle structures at the cladding interface and fusion welding joint, and eliminate various cladding and joining defects. The internal quality of the cladding layer and the fusion welding joint is excellent, and the bonding strength at the cladding interface and the fusion welding joint is high, the brazing sealing joint exhibits high bonding strength and good sealing performance, resulting in a combined joint between the titanium metal and the solder with excellent internal quality and high bonding strength. The combined joint between the titanium metal and the solder has good impact resistance, thermal insulation efficiency, and sealing performance, making the vessel have long service life.

### BRIEF DESCRIPTION OF THE DRAWINGS

FIG. 1 is a flow chart of joining dissimilar materials of a titanium metal and a solder for vacuum vessel sealing in an embodiment;

FIG. 2 is a front view of a bimetallic layer L formed by locally cladding a surface of a metal transition section 1 in an embodiment;

FIG. 3 is a top view of a bimetallic layer L formed by locally cladding a surface of a metal transition section 1 in an embodiment;

FIG. 4 is a front view of a stamped bimetallic structural part W formed by stamping and hole-making on a bimetallic layer L in an embodiment;

FIG. 5 is a top view of a stamped bimetallic structural part W formed by stamping and hole-making on a bimetallic layer L in an embodiment;

FIG. 6 is a cross-section diagram of A-A in FIG. 5;

FIG. 7 is a front view of a dissimilar material structural component S for vacuum sealing, formed by using a butt joint between a titanium metal 4 and a metal transition section 1 in a stamped bimetallic structural part W in an embodiment;

FIG. 8 is a top view of a dissimilar material structural component S for vacuum sealing, formed by using a butt joint between a titanium metal 4 and a metal transition section 1 in a stamped bimetallic structural part W in an embodiment;

FIG. 9 is a cross-section diagram of B-B in FIG. 8;

FIG. 10 is a front view of a dissimilar material structural component S for vacuum sealing, formed by using a lap joint between a titanium metal 4 and a metal transition section 1 in a stamped bimetallic structural part W in an embodiment;

FIG. 11 is a top view of a dissimilar material structural component S for vacuum scaling, formed by using a lap joint between a titanium metal 4 and a metal transition section 1 in a stamped bimetallic structural part W in an embodiment;

FIG. 12 is a cross-section diagram of C-C in FIG. 11;

FIG. 13 is a front perspective view of a dissimilar material structural component S for vacuum sealing in a butt joint in an embodiment;

FIG. 14 is a back perspective view of a dissimilar material structural component S for vacuum sealing in a butt joint in an embodiment;

FIG. 15 is a front perspective view of a dissimilar material structural component S for vacuum sealing in a lap joint in an embodiment; and

FIG. 16 is a back perspective view of a dissimilar material structural component S for vacuum sealing in a lap joint in an embodiment.

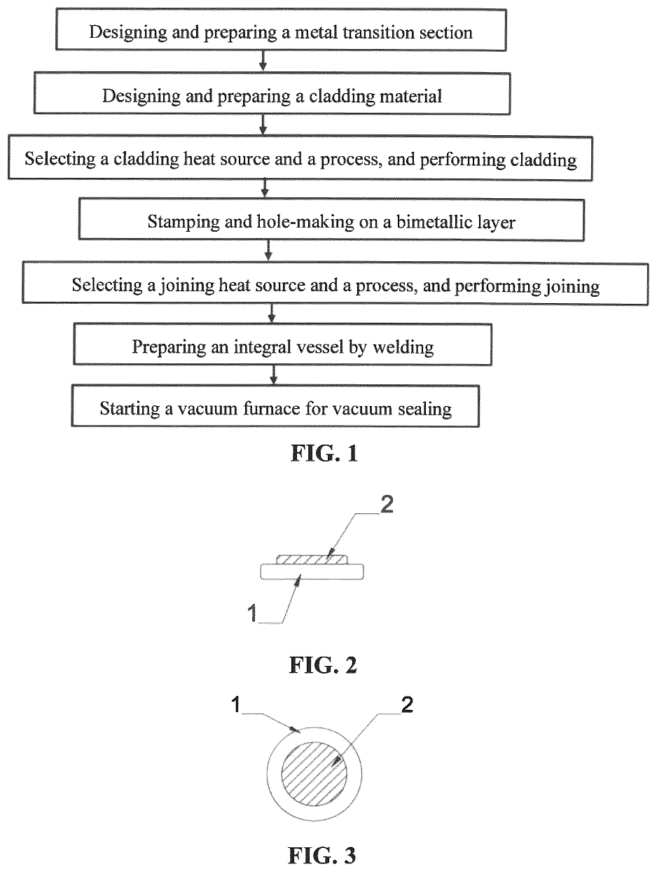

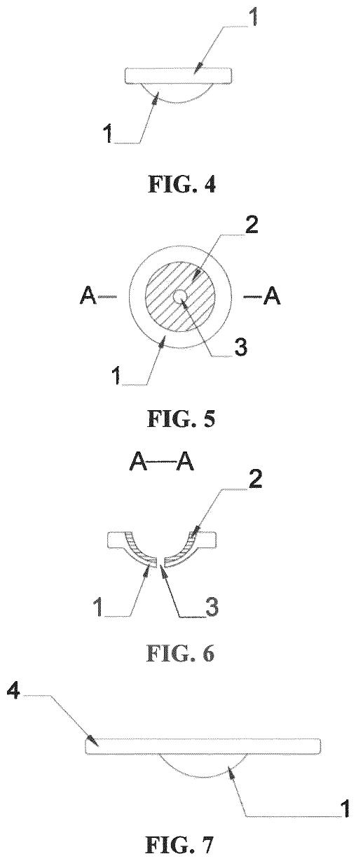

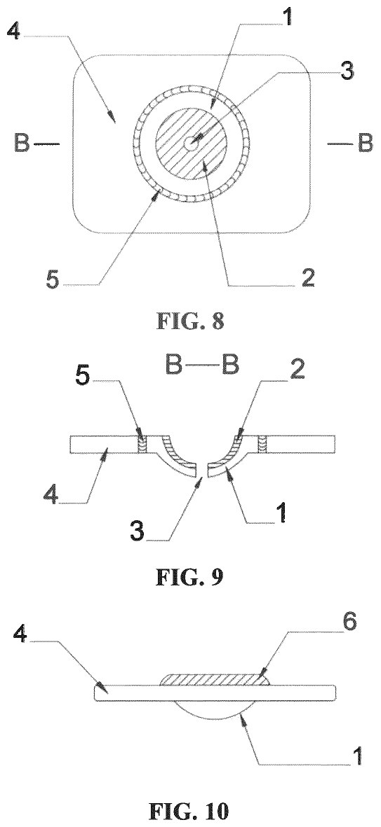

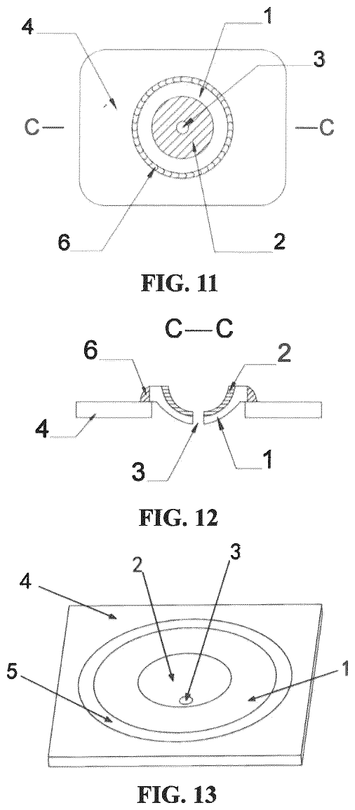

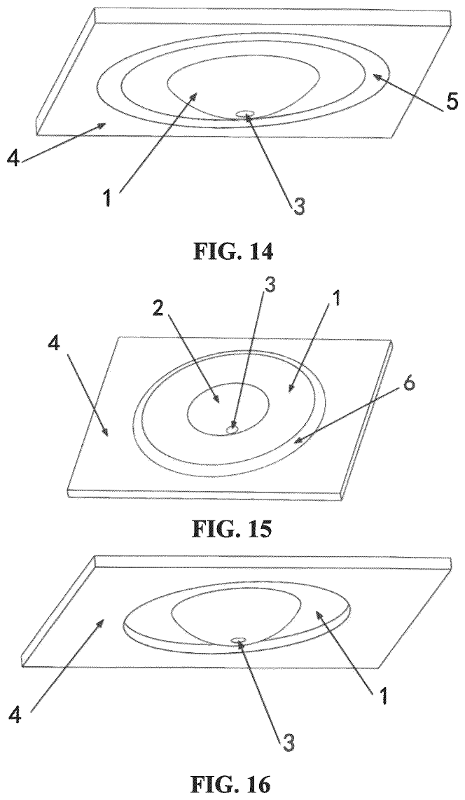

In the drawings;
1 represents metal transition section; 2 represents cladding layer; 3 represents stamped hole; 4 represents titanium metal; 5 represents butt weld; and 6 represents lap weld.

### DETAILED DESCRIPTION OF THE EMBODIMENTS

In order to make the objects, technical solutions, and advantages of the present disclosure more clearly, the present disclosure is further described in detail below with reference to the embodiments. It should be understood that specific embodiments described here are only used to illustrate rather than limiting the present disclosure.

An embodiment of the present disclosure provides a method for joining dissimilar materials of a titanium metal and a solder for vacuum vessel sealing, including the following steps:
1) designing and preparing a metal transition section 1 according to composition, physical and chemical properties of a titanium metal 4 to be joined, where the metal transition section 1 is required to exhibit good chemical compatibility with the titanium metal 4;
2) designing and preparing a cladding material R according to compositions, physical and chemical properties of the metal transition section 1 and a solder D, where the cladding material R is required to exhibit good plasticity, as well as good chemical compatibility with the metal transition section 1 and good wettability with the solder D;
3) selecting a cladding heat source and determining a cladding process corresponding to the cladding heat source, setting process parameters for the cladding heat source, starting a first heat source device, and locally cladding a surface of the metal transition section 1 by using the cladding material R to prepare a cladding layer 2, thus forming a bimetallic layer L composed of the cladding layer 2 and the metal transition section 1;
4) polishing a surface of the cladding layer 2, and stamping the bimetallic layer L from one surface of the cladding layer 2 by using a stamping device, to make the bimetallic layer L form a depression as well as a stamped hole 3 at a center, thus preparing a stamped bimetallic structural part W;
5) selecting a joining beat source and determining a joining process corresponding to the joining heat source, setting process parameters for the joining heat source, starting a second heat source device, and joining the titanium metal 4 and the metal transition section 1 in the stamped bimetallic structural part W to prepare a dissimilar material structural component S for vacuum sealing;
6) joining the dissimilar material structural component S for vacuum sealing with other parts of a vessel by welding to form a vessel V; and
7) placing the solder D at the stamped hole 3 formed by stamping the bimetallic layer of the vessel V, then placing the vessel V in a vacuum furnace, setting process parameters, and starting the vacuum furnace to perform vacuum sealing between the solder D and the vessel V, thus preparing a vacuum vessel.

Specifically, in Step 1), the metal transition section 1 is designed and prepared according to composition, physical and chemical properties of the titanium metal 4 to be joined, the metal transition section 1 is required to exhibit good chemical compatibility with the titanium metal 4 to ensure excellent weldability between the titanium metal 4 and the metal transition section 1, and prevent the formation of brittle structures which make the weld performance worse or even crack.

In Step 2), a cladding material R is designed and prepared according to the compositions, and the physical and chemical characteristics of the metal transition section 1 and a solder D, the cladding material R is required to exhibit good plasticity, as well as good chemical compatibility with the metal transition section 1 and good wettability with the solder D. Due to significant difference in physical properties, poor chemical compatibility, and poor wettability between the metal transition section 1 and the solder D, direct brazing joining cannot be achieved, it is required to clad on the metal transition section 1 to prepare the cladding layer 2 for indirection joining. Firstly, the cladding material R has good plasticity and low yield strength, therefore the prepared cladding layer 2 also exhibits good plasticity and ductility, allowing it to deform under low stress. Further, the plasticity deformation temperature of the cladding layer 2 is close to the softening temperature of the solder D, which can significantly reduce the stress on both the cladding layer 2 and the solder D during brazing and prevent cracking. Secondly, the cladding material R has good chemical compatibility with the metal transition section 1, ensuring the cladding layer 2 achieve strong metallurgical bonding with the base layer of the metal transition section 1 without forming brittle structures such as intermetallic compounds. Thirdly, since the cladding material R is required to exhibit good wettability with the solder D, the solder D can be spread evenly on the cladding layer 2 after melting, ensuring strong brazing bonding between the cladding layer 2 and the solder D. Fourthly, the cladding material R exhibits good plasticity, which ensures that the cladding layer 2 also possesses excellent plasticity and ductility. Additionally, the plasticity and strength of the metal transition section 1 are also moderate. As a result, the bimetallic layer achieves outstanding comprehensive mechanical properties and excellent stamping performance. The requirements for the next stamping process are satisfied, and accurate stamping shape can be obtained during stamping.

In Step 3), a cladding heat source is selected, and a cladding process corresponding to the cladding heat source is determined, process parameters for the cladding heat source are set, a first heat source device is started, and a surface of the metal transition section 1 is locally clad by using the cladding material R to prepare a cladding layer 2, thus forming a bimetallic layer L composed of the cladding layer 2 and the metal transition section 1. The metal transition section 1 is a base layer. As the metal transition section 1 has good chemical compatibility with the cladding material R, that is, the metallurgic compatibility is good, the formation of brittle structures and the cracks or even fractures can be avoided. Therefore, a cladding layer with high bonding strength and good formation, small stress and deformation, and excellent internal quality can be prepared by using a consumable electrode arc heat source, a non-consumable electrode are heat source, a plasma arc heat source, a laser heat source, and a laser—are hybrid heat source and the cladding processes corresponding the cladding heat sources, as well as controlling the process parameters, thereby obtaining a high-quality bimetallic layer L.

In Step 4), a surface of the cladding layer 2 is polished, the bimetallic layer L is stamped from one surface of the cladding layer 2 by using the stamping device, to make the bimetallic layer form a depression as well as a stamped hole 3 at a center, thus preparing the stamped bimetallic structural part W. Due to high comprehensive mechanical property and excellent stamping performance of the bimetallic layer L, the shape and precision of the stamped bimetallic structural part W prepared after stamping can meet the sealing requirements for the cladding layer 2 and the solder D in the next step. The stamped hole 3, also referred to as a vacuumizing hole, is used for vacuumizing a vessel.

In Step 5), a joining heat source is selected, and a joining process corresponding to the joining heat source is determined, process parameters for the joining heat source are set, a second heat source device is started, and the titanium metal 4 with the metal transition section 1 in the stamped bimetallic structural part W are joined to prepare a dissimilar material structural component S for vacuum sealing. The metal transition section 1 has good chemical compatibility with the titanium metal 4, i.e., the weldability is good. By optionally adding welding wire, the titanium metal 4 and the metal transition section 1 can be melted by using the heat source and the joining process corresponding the heat source, achieving a lap joint or a butt joint of the titanium metal 4 and the metal transition section 1. A weld formed after the solidification of a molten pool can avoid the formation of brittle structures and prevent cracking, resulting in the weld with excellent formation and internal quality, thereby achieving a high-quality joint.

In Step 6), the dissimilar material structural component S is joined with other parts of a vessel by welding to form a vessel V for vacuum sealing in the next step.

In Step 7), the solder D is placed at the stamped hole 3 formed by stamping the bimetallic layer of the vessel V, and then the vessel V is placed in the vacuum furnace, process parameters are set, the vacuum furnace is started to perform vacuum sealing between the solder D and the vessel V, thus preparing a vacuum vessel. Firstly, the solder D exhibits good wettability with the cladding layer 2 prepared from the cladding material R, which ensures excellent brazing performance, allowing the solder D to spread well on the cladding layer after melting, resulting in high bonding strength. Secondly, the cladding layer 2 has good plasticity and ductility, and the plastic deformation temperature of the cladding layer 2 is close to the softening temperature of the solder D. During brazing, the cladding layer can deform under low stress, and the generated stress can be significantly released due to the difference in the coefficients of linear expansion between the cladding layer 2 and the solder D. This greatly reduces or even eliminates residual stress, ensuring high bonding strength between the solder D and the cladding layer 2, and preventing cracking.

In some embodiments, the titanium metal includes pure titanium and a titanium alloy. The wide range of applicable of the titanium metal makes it convenient to select appropriate titanium metal according to actual requirements.

In some embodiments, the solder D includes a metal solder (metal brazing filler) and an inorganic solder (inorganic brazing filler). The metal solder has good fluidity after melting, enabling it to wet the metal surface for brazing joining. The inorganic solder includes oxide, fluoride, etc., which can form glass phase after melting, allowing it to wet the metal surface for brazing joining. The wide range of applicable of the solder enables brazing joining from low temperatures to high temperatures.

In some embodiments, the cladding material R includes a form of a welding wire and a powder. This variety makes it more convenient to select the appropriate cladding material according to the characteristics of the cladding heat source, the cladding process, and the composition, physical properties, and thickness of the metal transition section 1.

In some embodiments, the metal transition section 1 has good plasticity, ensuring that the prepared bimetallic layer exhibits excellent stamping performance to meet the requirements for the stamping process.

In some embodiments, the joining between the titanium metal 4 and the metal transition section 1 in the stamped bimetallic structural part W is conducted by using a butt joint or a lap joint. This approach is suitable for different joining heat sources and corresponding joining processes, and different material thicknesses, enabling convenient and fast joining.

In some embodiments, the cladding heat source includes a consumable electrode arc heat source, a non-consumable electrode arc heat source, a plasma arc heat source, a laser heat source, or a laser-arc hybrid heat source. These heat sources are used to melt the cladding material and the base layer of the metal transition section 1, forming the cladding layer 2.

In some embodiments, the consumable electrode are heat source, the non-consumable electrode are heat source, the plasma arc heat source, the laser heat source, and the laser-arc hybrid heat source each are used for cladding under inert gas protection. This ensures excellent internal quality and formation of the cladding layer. Moreover, shielding gas, as a medium for generating arc and plasma arc, is configured to maintain the stable combustion of the are and the plasma arc. The cladding process is stable when the consumable electrode are heat source, the non-melting electrode arc heat source, the plasma arc heat source, and the laser-arc hybrid heat source are used.

In some embodiments, the cladding process corresponding to the consumable electrode are heat source is consumable electrode arc welding; the cladding process corresponding to the non-consumable electrode arc heat source is non-consumable electrode arc welding with filler wire; the cladding process corresponding to the plasma arc heat source is plasma spray welding or plasma welding with filler wire; the cladding process corresponding to the laser heat source is laser welding with filler wire or powder feeding laser cladding; and the cladding process corresponding to the laser-arc hybrid heat source is laser-consumable electrode aro hybrid welding. These processes enable cladding on the metal transition sections with different thicknesses and different compositions, improving cladding efficiency and formation quality.

In some embodiments, the jointing heat source includes a consumable electrode arc heat source, a non-consumable electrode arc heat source, a plasma arc heat source, an electron beam heat source, a laser heat source, or a laser-arc hybrid heat source. These heat sources each are used to melt the titanium metal, the metal transition section, and the welding material for joining.

In some embodiments, the consumable electrode arc heat source, the non-consumable electrode arc heat source, the plasma arc heat source, the laser heat source, and the laser-arc hybrid heat source each are used for joining under inert gas protection to ensure the internal quality of the weld and the formation of the weld excellent. Moreover, shielding gas, as a medium for generating are and plasma arc, is configured to maintain the stable combustion of the arc and the plasma arc. The joining process is stable when the consumable electrode are heat source, the non-melting electrode are heat source, the plasma arc heat source, and the laser-arc hybrid heat source are used.

In some embodiments, the electron beam heat source is used for welding under a vacuum condition. This ensures that the electron beam welding process is stable and prevent the metal from oxidizing, making the internal quality and the formation of the weld excellent.

In some embodiments, the joining process corresponding to the consumable electrode are heat source is consumable electrode arc welding; the joining process corresponding to the non-consumable electrode arc heat source is non-consumable electrode arc welding or non-consumable electrode arc welding with filler wire; the joining process corresponding to the plasma arc heat source is plasma spray welding or plasma welding with filler wire; the joining process corresponding to the electron beam heat source is vacuum electron beam welding; the joining process corresponding to the laser heat source is pure laser welding or laser welding with filler wire; and the joining process corresponding to the laser-arc hybrid heat source is laser-consumable electrode arc hybrid welding. These processes enable the joining of the titanium metal and the metal transition sections with different thicknesses and different compositions, enhancing both the joining efficiency and the formation quality.

In some embodiments, a welding material for the consumable electrode arc welding, the non-consumable electrode arc welding with filler wire, the plasma welding with filler wire, the laser welding with filler wire, or the laser-consumable electrode arc hybrid welding is a welding wire H, which is required to exhibit good chemical compatibility with both the titanium metal 4 and the metal transition section 1. The welding wire can inhibit defects, improve the weld formation, prevent the formation of brittle structures, avoid cracking, and enhance welding quality.

In some embodiments, a welding mode for the consumable electrode are welding includes a CMT (cold metal transfer) mode, a pulse model, a direct current mode, or an alternating current mode. An appropriate welding mode can be conveniently selected according to the compositions, physical and chemical properties, and plate thicknesses of the titanium metal 4 and the metal transition section 1, as well as the composition, physical and chemical properties, and diameter of the welding wire, thus accurately controlling thermal input and temperature, reducing stress and deformation, preventing grain coarsening in the heat-affected zone, avoiding welding penetration caused by excessive heat input, avoiding the problems such as incomplete penetration caused by small thermal input, eliminating joining and cladding defects, ensuring excellent formation, internal quality, and performance of the weld and the cladding layer.

In some embodiments, a welding mode for the non-consumable electrode arc welding includes a pulse model, a direct current mode, or an alternating current model. An appropriate welding mode can be conveniently selected according to the compositions, physical and chemical properties, and plate thicknesses of the titanium metal 4 and the metal transition section 1, as well as the composition, physical and chemical properties, and diameter of the welding wire, thus accurately controlling thermal input and temperature, reducing stress and deformation, preventing grain coarsening in the heat-affected zone, avoiding welding penetration caused by excessive heat input, avoiding the problems such as incomplete penetration caused by small thermal input, eliminating joining and cladding defects, ensuring excellent formation, internal quality, and performance of the weld and the cladding layer.

In some embodiments, the vacuum vessel sealing is conducted under a vacuum condition, which facilitates brazing joining at an appropriate degree of vacuum, prevents metal oxidation, and improves brazing quality and bonding strength.

The method for joining dissimilar materials of a titanium metal and a solder for vacuum vessel sealing is simple in joining process, excellent in welding flexibility, high in joining efficiency, low in joining cost, high in joining quality, small in stress and deformation, and capable of preventing grain coarsening in the heat-affected zone, avoiding the formation of brittle structures, eliminating defects in various cladding, fusion joining, and brazing joining. The combined joint between the titanium metal and the solder exhibits excellent internal quality, high bonding strength, as well as superior impact resistance, thermal insulation efficiency, and sealing performance, making the service life of the vessel long.

To better illustrate the method for joining dissimilar materials of the titanium metal and the solder for vacuum vessel sealing provided by the present disclosure, the following is a further illustration by examples.

### Example 1

In a method for joining dissimilar materials of a titanium metal and a solder for vacuum vessel sealing, the joining materials were TA1 pure titanium and solder D1, where the solder D1 was an inorganic solder and had composition shown in Table 1. These two materials exhibited poor chemical compatibility, significant difference in thermal physical properties, and poor wettability. To perform dissimilar material joining of the TA1 pure titanium and the solder D1, the method was performed as follows:
1) A metal transition section 11 was designed and prepared according to composition, physical and chemical properties of the TA1 pure titanium to be joined, where the composition of the metal transition section 11 was as shown in Table 2, and the metal transition section 11 exhibited good chemical compatibility with the TA1 pure titanium.
2) A cladding material R1 was designed and prepared according to compositions, physical and chemical properties of the metal transition section 11 and the solder D1, where the cladding material R1 was a welding wire, the composition of which was shown in Table 3, the cladding material R1 exhibited good plasticity, as well as good chemical compatibility with the metal transition section 11 and good wettability with the solder D1.
3) A consumable electrode arc heat source was used as a cladding heat source, and consumable electrode arc welding was determined as a cladding process corresponding to the ladding heat source, process parameters for the consumable electrode arc heat source were set, a CMT mode was employed as a welding mode with inert gas protection, a consumable electrode arc heat source device was then started to locally clad a surface of the metal transition section 11 by using the cladding material R1 to prepare a cladding layer 21, thus forming a bimetallic layer L1 composed of the cladding layer 21 and the metal transition section 11.
4) A surface of the cladding layer 21 was polished, and the bimetallic layer L1 was stamped from one surface of the cladding layer 21 by using a stamping device, to make the bimetallic layer L1 form a depression as well as a stamped hole 31 at a center, thus preparing a stamped bimetallic structural part W1.
5) A consumable electrode arc heat source was used as a joining heat source, consumable electrode arc welding was determined as a joining process corresponding to the joining heat source, process parameters for the consumable electrode are heat source were set, a CMT mode was employed as a welding mode with inert gas protection, and the composition of a welding wire H1 was as shown in Table 2, where the welding wire H1 exhibited good chemical compatibility with the TA1 pure titanium and the metal transition section 11, the joining mode was a lap joint, and a consumable electrode arc heat source device was started, and the TA1 pure titanium with the metal transition section 11 in the stamped bimetallic structural part W1 were joined to prepare a dissimilar material structural component S1 for vacuum sealing.
6) The dissimilar material structural component S1 for vacuum sealing was joined with other parts of a vessel by welding to form a vessel V1.
7) The solder D1 was placed at the stamped hole 31 formed by stamping the bimetallic layer of the vessel V1, then the vessel V1 was placed in a vacuum furnace, process parameters were set, and the vacuum furnace was started to perform vacuum sealing between the solder D1 and the vessel V1, thereby preparing a vacuum vessel.

TABLE 1
Composition and content of solder D1

Composition and content (wt %)

| Material name | PbO | B₂O₃ | Al₂O₃ | SiO₂ | CuO |
|---|---|---|---|---|---|
| Solder D1 | 77 | 20 | 1.2 | 1.0 | 0.8 |

TABELE 2
Compositions and contents of metal transition section 11 and welding wire
H1

| | Composition and content (wt %) | | | | | | | | | |
|---|---|---|---|---|---|---|---|---|---|---|
| Material name | Nb | Zr | Cu | Ti | Ta | C | Si | Fe | W | Mo |
| Metal transition | 99.85 | 0.016 | 0.001 | 0.01 | 0.1 | | 0.005 | | 0.008 | 0.01 |
| section 11 | | | | | | | | | | |
| Welding wire H1 | | | | 99.9 | | 0.03 | | 0.07 | | |

TABLE 3
Composition and content of cladding material R1

| | Composition and content (wt %) | | | | | | | |
|---|---|---|---|---|---|---|---|---|
| Material name | Cu | Sn | Mn | Fe | Si | Ni | Al | Co |
| Cladding material R1 | 98.4 | 1.0 | 0.24 | 0.03 | 0.24 | 0.04 | 0.01 | 0.04 |

### Example 2

In a method for joining dissimilar materials of a titanium metal and a solder for vacuum vessel sealing, the joining materials were TA2 pure titanium and solder D2, where the solder D2 was an inorganic solder and had composition shown in Table 4. These two materials exhibited poor chemical compatibility, significant difference in thermal physical properties, and poor wettability. To perform dissimilar material joining of the TA2 pure titanium and the solder D2, the method was performed as follows:
1) A metal transition section 12 was designed and prepared according to composition, physical and chemical properties of the TA2 pure titanium to be joined, where the composition of the metal transition section 12 was as shown in Table 5, and the metal transition section 12 exhibited good chemical compatibility with the TA2 pure titanium.
2) A cladding material R2 was designed and prepared according to compositions, physical and chemical properties of the metal transition section 12 and the solder D2, where the cladding material R2 was a welding wire, the composition of which was shown in Table 6, the cladding material R2 exhibited good plasticity, as well as good chemical compatibility with the metal transition section 12 and good wettability with the solder D2.
3) A consumable electrode arc heat source was used as a cladding heat source, and consumable electrode arc welding was determined as a cladding process corresponding to the ladding heat source, process parameters for the consumable electrode arc heat source were set, an alternating current mode was employed as a welding mode with inert gas protection, a consumable electrode arc heat source device was then started to locally clad a surface of the metal transition section 12 by using the cladding material R2 to prepare a cladding layer 22, thus forming a bimetallic layer L2 composed of the cladding layer 22 and the metal transition section 12.
4) A surface of the cladding layer 22 was polished, and the bimetallic layer L2 was stamped from one surface of the cladding layer 22 by using a stamping device, to make the bimetallic layer L2 form a depression as well as a stamped hole 32 at a center, thus preparing a stamped bimetallic structural part W2.
5) A consumable electrode arc heat source was used as a joining heat source, consumable electrode arc welding was determined as a joining process corresponding to the joining heat source, process parameters for the consumable electrode are heat source were set, a pulse mode was employed as a welding mode with inert gas protection, and the composition of a welding wire H2 was as shown in Table 5, where the welding wire H2 exhibited good chemical compatibility with the TA2 pure titanium and the metal transition section 12, the joining mode was a butt joint, and a consumable electrode arc heat source device was started, and the TA2 pure titanium with the metal transition section 12 in the stamped bimetallic structural part W2 were joined to prepare a dissimilar material structural component S2 for vacuum sealing.
6) The dissimilar material structural component S2 for vacuum sealing was joined with other parts of a vessel by welding to form a vessel V2.
7) The solder D2 was placed at the stamped hole 32 formed by stamping the bimetallic layer of the vessel V2, then the vessel V2 was placed in a vacuum furnace, process parameters were set, and the vacuum furnace was started to perform vacuum sealing between the solder D2 and the vessel V2, thereby preparing a vacuum vessel.

TABLE 4
Composition and content of solder D2

| Material | Composition and content (wt %) | | | | | |
|---|---|---|---|---|---|---|
| name | PbO | B₂O₃ | Al₂O₃ | SiO₂ | CuO | CrO₂ |
| Solder D2 | 75 | 21 | 1.5 | 1.0 | 0.7 | 0.8 |

TABLE 5
Compositions and contents of metal transition section 22 and welding wire H2

| | Composition and content (wt %) | | | | | | | | | |
|---|---|---|---|---|---|---|---|---|---|---|
| Material name | Nb | Zr | Ti | Ta | Fe | Ni | Si | W | Mo | Al |
| Metal transition | 99.95 | 0.001 | 0.002 | 0.04 | 0.001 | 0.001 | | 0.002 | 0.001 | 0.002 |
| section 22 | | | | | | | | | | |
| Welding wire H2 | | | 99.57 | | 0.15 | | 0.08 | | | 0.2 |

TABLE 6
Composition and content of cladding material R2

| Material | Composition and content (wt %) | | | | | | | |
|---|---|---|---|---|---|---|---|---|
| name | Cu | Ag | Bi | Fe | Sa | Ni | P | Zn |
| Cladding | 99.93 | 0.056 | 0.001 | 0.004 | 0.002 | 0.002 | 0.002 | 0.003 |
| material R2 | | | | | | | | |

### Example 3

In a method for joining dissimilar materials of a titanium metal and a solder for vacuum vessel sealing, the joining materials were TA3 pure titanium and solder D3, where the solder D3 was an inorganic solder and had composition shown in Table 7. These two materials exhibited poor chemical compatibility, significant difference in thermal physical properties, and poor wettability. To perform dissimilar material joining of the TA3 pure titanium and the solder D3, the method was performed as follows:
1) A metal transition section 13 was designed and prepared according to composition, physical and chemical properties of the TA3 pure titanium to be joined, where the composition of the metal transition section 13 was as shown in Table 8, and the metal transition section 13 exhibited good chemical compatibility with the TA3 pure titanium.
2) A cladding material R3 was designed and prepared according to the compositions, physical and chemical properties of the metal transition section 13 and the solder D3, where the cladding material R3 was a welding wire, the composition of which was shown in Table 9, the cladding material R3 exhibited good plasticity, as well as good chemical compatibility with the metal transition section 13 and good wettability with the solder D3
3) A non-consumable electrode are heat source was used as a cladding heat source, and non-consumable electrode arc welding with filler wire was determined as a cladding process corresponding to the ladding heat source, process parameters for the non-consumable electrode arc heat source were set, inert gas protection was employed, a non-consumable electrode arc heat source device was then started to locally clad a surface of the metal transition section 13 by using the cladding material R3 to prepare a cladding layer 23, thus forming a bimetallic layer L3 composed of the cladding layer 23 and the metal transition section 13.
4) A surface of the cladding layer 23 was polished, and the bimetallic layer L3 was stamped from one surface of the cladding layer 23 by using a stamping device, to make the bimetallic layer L3 form a depression as well as a stamped hole 33 at a center, thus preparing a stamped bimetallic structural 3.
5) A laser heat source was used as a joining heat source, pure laser welding was determined as a joining process corresponding to the joining heat source, process parameters for the laser heat source were set, inert gas protection was employed, the joining mode was a butt joint, and a laser heat source device was started, and the TA3 pure titanium with the metal section 13 in the stamped bimetallic structural part W3 were joined to prepare a dissimilar material structural component S3 for vacuum sealing.
6) The dissimilar material structural component S3 for vacuum sealing was joined with other parts of a vessel by welding to form a vessel V3.
7) The solder D3 was placed at the stamped hole 33 formed by stamping the bimetallic layer of the vessel V3, then the vessel V3 was placed in a vacuum furnace, process parameters were set, and the vacuum furnace was started to perform vacuum sealing between the solder D3 and the vessel V3, thereby preparing a vacuum vessel.

TABLE 7
Composition and content of solder D3

| Material | Composition and content (wt %) | | | | | |
|---|---|---|---|---|---|---|
| name | Bi₂O₃ | Al₂O₃ | B₂O₃ | SiO₂ | CuO | ZnO |
| Solder D3 | 77 | 4 | 16 | 1.4 | 0.9 | 0.7 |

TABLE 8
Composition and content of metal transition section 33

| | Composition and content (wt %) | | | | | | | | | |
|---|---|---|---|---|---|---|---|---|---|---|
| Material name | Nb | Ti | Fe | V | Si | Mo | Zr | Ni | Cr | Ta |
| Metal transition | 99.44 | 0.007 | 0.01 | 0.24 | 0.01 | 0.01 | 0.02 | 0.01 | 0.003 | 0.25 |
| section 33 | | | | | | | | | | |

TABLE 9
Composition and content of cladding material R3

| Material | Composition and content (wt %) | | | | | | | |
|---|---|---|---|---|---|---|---|---|
| name | Cu | Ag | Bi | Fe | Sn | Ni | Mn | Zn |
| Cladding | 99.99 | 0.002 | 0.001 | 0.001 | 0.001 | 0.001 | 0.002 | 0.002 |
| material R3 | | | | | | | | |

### Example 4

In a method for joining dissimilar materials of a titanium metal and a solder for vacuum vessel sealing, the joining materials were TAIG pure titanium and solder D4, where the solder D4 was an inorganic solder and had composition shown in Table 10. These two materials exhibited poor chemical compatibility, significant difference in thermal physical properties, and poor wettability. To perform dissimilar material joining of the TAIG pure titanium and the solder D4, the method was performed as follows;
1) A metal transition section 14 was designed and prepared according to composition, physical and chemical properties of the TAIG pure titanium to be joined, where the composition of the metal transition section 14 was as shown in Table 11, and the metal transition section 14 exhibited good chemical compatibility with the TAIG pure titanium.
2) A cladding material R4 was designed and prepared according to the compositions, physical and chemical properties of the metal transition section 14 and the solder D4, where the cladding material R4 was a powder, the composition of which was shown in Table 12, the cladding material R4 exhibited good plasticity, as well as good chemical compatibility with the metal transition section 14 and good wettability with the solder D4.
3) A plasma arc heat source was used as a cladding heat source, and plasma spray welding was determined as a cladding process corresponding to the ladding heat source, process parameters for the plasma are heat source were set, inert gas protection was employed, a plasma arc heat source device was then started to locally clad a surface of the metal transition section 14 by using the cladding material R4 to prepare a cladding layer 24, thus forming a bimetallic layer LA composed of the cladding layer 24 and the metal transition section 14.
4) A surface of the cladding layer 24 was polished, and the bimetallic layer L4 was stamped from one surface of the cladding layer 24 by using a stamping device, to make the bimetallic layer L4 form a depression as well as a stamped hole 34 at a center, thus preparing a stamped bimetallic structural part W4.
5) A non-consumable electrode arc heat source was used as a joining heat source, non-consumable electrode are welding with filler wire was determined as a joining process corresponding to the joining heat source, process parameters for the non-consumable electrode are heat source were set, inert gas protection was employed, the composition of a welding wire H4 was as shown in Table 11, where the welding wire H4 exhibited good chemical compatibility with the TAIG pure titanium and the metal transition section 14, the joining mode was a lap joint, and a non-consumable electrode arc heat source device was started, and the TAIG pure titanium with the metal transition section 14 in the stamped bimetallic structural part W4 were joined to prepare a dissimilar material structural component $4 for vacuum sealing.
6) The dissimilar material structural component S4 for vacuum sealing was joined with other parts of a vessel by welding to form a vessel V4.
7) The solder D4 was placed at the stamped hole 34 formed by stamping the bimetallic layer of the vessel V4, then the vessel V4 was placed in a vacuum furnace, process parameters were set, and the vacuum furnace was started to perform vacuum sealing between the solder D4 and the vessel V4, thereby preparing a vacuum vessel.

TABLE 10
Composition and content of solder D4

| | Composition and content (wt %) | | | | | |
|---|---|---|---|---|---|---|
| Material name | SnO₂ | ZnO | MoO₂ | B₂O₃ | CuO | SiO₂ |
| Solder D4 | 88 | 6 | 4 | 1 | 0.5 | 0.5 |

TABLE 11
Compositions and contents of metal transition section 34 and welding wire H4

| | Composition and content (wt %) | | | | | | | | | |
|---|---|---|---|---|---|---|---|---|---|---|
| Material name | Nb | Ti | Fe | C | Si | W | Zr | Ni | Mo | Ta |
| Metal transition | 99.34 | 0.03 | 0.01 | 0.01 | 0.002 | 0.05 | 0.005 | 0.003 | 0.05 | 0.5 |
| section 34 | | | | | | | | | | |
| Welding wire H4 | | 99.6 | 0.3 | 0.05 | 0.05 | | | | | |

TABLE 12
Composition and content of cladding material R4

| | Composition and content (wt %) | | | | | | | |
|---|---|---|---|---|---|---|---|---|
| Material name | Cu | Ag | Mn | Fe | Si | Ni | Co | Al |
| Cladding | 99.3 | 0.31 | 0.2 | 0.05 | 0.1 | 0.01 | 0.02 | 0.01 |
| material R4 | | | | | | | | |

### Example 5

In a method for joining dissimilar materials of a titanium metal and a solder for vacuum vessel sealing, the joining materials were TA2G pure titanium and solder D5, where the solder D5 was an inorganic solder and had composition shown in Table 13. These two materials exhibited poor chemical compatibility, significant difference in thermal physical properties, and poor wettability. To perform dissimilar material joining of the TA2G pure titanium and the solder D5, the method was performed as follows:
1) A metal transition section 15 was designed and prepared according to composition, physical and chemical properties of the TA2G pure titanium to be joined, where the composition of the metal transition section 15 was as shown in Table 14, and the metal transition section 15 exhibited good chemical compatibility with the TA2G pure titanium,
2) A cladding material R5 was designed and prepared according to compositions, physical and chemical properties of the metal transition section 15 and the solder D5, where the cladding material R5 was a welding wire, the composition of which was shown in Table 15, the cladding material R5 exhibited good plasticity, as well as good chemical compatibility with the metal transition section 15 and good wettability with the solder D5.
3) A plasma arc heat source was used as a cladding beat source, and plasma welding with filler wire was determined as a cladding process corresponding to the ladding heat source, process parameters for the plasma arc heat source were set, inert gas protection was employed, a plasma arc heat source device was then started to locally clad a surface of the metal transition section 15 by using the cladding material R5 to prepare a cladding layer 25, thus forming a bimetallic layer L5 composed of the cladding layer 25 and the metal transition section 15.
4) A surface of the cladding layer 25 was polished, and the bimetallic layer L5 was stamped from one surface of the cladding layer 25 by using a stamping device, to make the bimetallic layer L5 form a depression as well as a stamped hole 35 at a center, thus preparing a stamped bimetallic structural part W5.
5) A laser heat source was used as a joining heat source, laser welding with filler wire was determined as a joining process corresponding to the joining heat source, process parameters for the laser heat source were set, inert gas protection was employed, the composition of a welding wire H5 was as shown in Table 14, where the welding wire H5 exhibited good chemical compatibility with the TA2G pure titanium and the metal transition section 15, the joining mode was a lap joint, and a laser heat source device was started, and the TA2G pure titanium with the metal transition section 15 in the stamped bimetallic structural part W5 were joined to prepare a dissimilar material structural component S5 for vacuum sealing.
6) The dissimilar material structural component S5 for vacuum sealing was joined with other parts of a vessel by welding to form a vessel V5.
7) The solder D5 was placed at the stamped hole 35 formed by stamping the bimetallic layer of the vessel V5, then the vessel V5 was placed in a vacuum furnace, process parameters were set, and the vacuum furnace was started to perform vacuum sealing between the solder D5 and the vessel V5, thereby preparing a vacuum vessel.

TABLE 13
Composition and content of solder DS

| Material | Composition and content (wt %) | | | | | |
|---|---|---|---|---|---|---|
| name | SnO₂ | ZnO | Bi₂O₃ | B₂O₃ | CoO | SiO₂ |
| Solder D5 | 37 | 9 | 40 | 7.5 | 1.5 | 5 |

TABLE 14
Compositions and contents of metal transition section 15 and welding wire H5

| | Composition and content (wt %) | | | | | | | | | |
|---|---|---|---|---|---|---|---|---|---|---|
| Material name | Nb | Ti | Fe | C | Si | W | Zr | V | Mo | Al |
| Metal transition | 99.81 | | 0.01 | 0.03 | 0.01 | 0.06 | 0.04 | 0.02 | 0.02 | |
| section 15 | | | | | | | | | | |
| Welding wire H5 | | 99.73 | 0.16 | 0.03 | 0.05 | | | | | 0.03 |

TABLE 15
Composition and content of cladding material R5

| Material | Composition and content (wt %) | | | | | | | |
|---|---|---|---|---|---|---|---|---|
| name | Cu | Sn | Mn | Fe | Si | Ni | Co | Al |
| Cladding | 98.08 | 1.0 | 0.4 | 0.02 | 0.4 | 0.06 | 0.03 | 0.01 |
| material R5 | | | | | | | | |

### Example 6

In a method for joining dissimilar materials of a titanium metal and a solder for vacuum vessel sealing, the joining materials were TA30 pure titanium and solder D6, where the solder D6 was an inorganic solder and had composition shown in Table 16. These two materials exhibited poor chemical compatibility, significant difference in thermal physical properties, and poor wettability. To perform dissimilar material joining of the TA3G pure titanium and the solder D6, the method was perform as follows:
1) A metal transition section 16 was designed and prepared according to composition, physical and chemical properties of the TA3G pure titanium to be joined, where the composition of the metal transition section 16 was as shown in Table 17, and the metal transition section 16 exhibited good chemical compatibility with the TA3G pure titanium.
2) A cladding material R6 was designed and prepared according to compositions, physical and chemical properties of the metal transition section 16 and the solder D6, where the cladding material R6 was a welding wire, the composition of which was shown in Table 18, the cladding material R6 exhibited good plasticity, as well as good chemical compatibility with the metal transition section 16 and good wettability with the solder D6.
3) A consumable electrode arc heat source was used as a cladding heat source, and consumable electrode arc welding was determined as a cladding process corresponding to the ladding heat source, process parameters for the consumable electrode are heat source were set, a direct current mode was employed as a welding mode with inert gas protection, a consumable electrode arc heat source device was then started to locally clad a surface of the metal transition section 16 by using the cladding material R6 to prepare a cladding layer 26, thus forming a bimetallic layer L6 composed of the cladding layer 26 and the metal transition section 16.
4) A surface of the cladding layer 26 was polished, and the bimetallic layer L6 was stamped from one surface of the cladding layer 26 by using a stamping device, to make the bimetallic layer L6 form a depression as well as a stamped hole 36 at a center, thus preparing a stamped bimetallic structural part W6.
5) An electron beam beat source was used as a joining heat source, electron beam welding was determined as a joining process corresponding to the joining heat source, process parameters for the electron beam heat source were set, the joining was conducted under a vacuum condition, the joining mode was a butt joint, and an electron beam heat source device was started, and the TA3G pure titanium with the metal transition section 16 in the stamped bimetallic structural part W6 were joined to prepare a dissimilar material structural component S6 for vacuum sealing.
6) The dissimilar material structural component S6 for vacuum sealing was joined with other parts of a vessel by welding to form a vessel V6.
7) The solder D6 was placed at the stamped hole 36 formed by stamping the bimetallic layer of the vessel V6, then the vessel V6 was placed in a vacuum furnace, process parameters were set, and the vacuum furnace was started to perform vacuum sealing between the solder D6 and the vessel V6, thereby preparing a vacuum vessel.

TABLE 16
Composition and content of solder D6

| Material | Composition and content (wt %) | | | | | | |
|---|---|---|---|---|---|---|---|
| name | SnO₂ | PbO | B₂O₃ | ZnO | Bi₂O₃ | SrO | SiO₂ |
| Solder D6 | 29 | 43 | 4 | 5 | 12 | 3 | 4 |

TABLE 17
Composition and content of metal transition section 16

| | Composition and content (wt %) | | | | | | | | | |
|---|---|---|---|---|---|---|---|---|---|---|
| Material name | Nb | Ti | Fe | C | Ta | W | Zr | Si | Ni | Al |
| Metal transition | 97.08 | 1.2 | | 0.015 | 0.5 | 0.5 | 0.7 | | 0.005 | |
| section 16 | | | | | | | | | | |

TABLE 18
Composition and content of cladding material R6

| | Composition and content (wt %) | | | | | | | |
|---|---|---|---|---|---|---|---|---|
| Material name | Cu | Zr | Bi | Fe | Sn | Ni | P | Zn |
| Cladding | 99.83 | 0.156 | 0.001 | 0.004 | 0.002 | 0.002 | 0.002 | 0.003 |
| material R6 | | | | | | | | |

### Example 7

In a method for joining dissimilar materials of a titanium metal and a solder for vacuum vessel sealing, the joining materials were TA4G pure titanium and solder D7, where the solder D7 was an inorganic solder and had composition shown in Table 19. These two materials exhibited poor chemical compatibility, significant difference in thermal physical properties, and poor wettability. To perform dissimilar material joining of the TA4G pure titanium and the solder D7, the method was performed as follows:
1) A metal transition section 17 was designed and prepared according to composition, physical and chemical properties of the TA4G pure titanium to be joined, where the composition of the metal transition section 17 was as shown in Table 20, and the metal transition section 17 exhibited good chemical compatibility with the TA4G pure titanium.
2) A cladding material R7 was designed and prepared according to the compositions, physical and chemical properties of the metal transition section 17 and the solder D7, where the cladding material R7 was a welding wire, the composition of which was shown in Table 21, the cladding material R7 exhibited good plasticity, as well as good chemical compatibility with the metal transition section 17 and good wettability with the solder D7.
3) A consumable electrode arc heat source was used as a cladding heat source, and consumable electrode arc welding was determined as a cladding process corresponding to the ladding heat source, process parameters for the consumable electrode are heat source were set, a pulse mode was employed as a welding mode with inert gas protection, a consumable electrode arc heat source device was then started to locally clad a surface of the metal transition section 17 by using the cladding material R7 to prepare a cladding layer 27, thus forming a bimetallic layer L7 composed of the cladding layer 27 and the metal transition section 17.
4) A surface of the cladding layer 27 was polished, and the bimetallic layer L7 was stamped from one surface of the cladding layer 27 by using a stamping device, to make the bimetallic layer L7 form a depression as well as a stamped hole 37 at a center, thus preparing a stamped bimetallic structural part W7.
5) A plasma are heat source was used as a joining heat source, plasma arc welding was determined as a joining process corresponding to the joining heat source, process parameters for the plasma arc heat source were set, the inert gas protection was employed, the joining mode was a butt joint, and a plasma arc heat source device was started, and the TA4G pure titanium with the metal transition section 17 in the stamped bimetallic structural part W7 were joined to prepare a dissimilar material structural component S7 for vacuum sealing.
6) The dissimilar material structural component S7 for vacuum sealing was joined with other parts of a vessel by welding to form a vessel V7.
7) The solder D7 was placed at the stamped hole 37 formed by stamping the bimetallic layer of the vessel V7, then the vessel V7 was placed in a vacuum furnace, process parameters were set, and the vacuum furnace was started to perform vacuum sealing between the solder D7 and the vessel V7, thereby preparing a vacuum vessel.

TABLE 19
Composition and content of solder D7

| Material | Composition and content (wt %) | | | | | | |
|---|---|---|---|---|---|---|---|
| name | SiO₂ | BaO | B₂O₃ | Al₂O₃ | CoO | P₂O₅ | Li₂O |
| Solder D7 | 50 | 20 | 14 | 4 | 1 | 3 | 8 |

TABLE 20
Composition and content of metal transition section 17

| | Composition and content (wt %) | | | | | | | | | |
|---|---|---|---|---|---|---|---|---|---|---|
| Material name | Nb | Ti | Fe | C | Ta | V | Zr | Mo | Si | Al |
| Metal transition | 95.5 | | 0.02 | 0.05 | 0.1 | 1.5 | 1.1 | 1.7 | 0.01 | 0.02 |
| section 17 | | | | | | | | | | |

TABLE 21
Composition and content of cladding material R7

| | Composition and content (wt %) | | | | | | | |
|---|---|---|---|---|---|---|---|---|
| Material name | Cu | Sn | Zn | Fe | Mn | Si | Al | Ni |
| Cladding | 94.04 | 1.2 | 1.2 | 0.3 | 1.1 | 2.1 | 0.05 | 0.01 |
| material R7 | | | | | | | | |

### Example 8

In a method for joining dissimilar materials of a titanium metal and a solder for vacuum vessel sealing, the joining materials were TA10 titanium alloy and solder D8, where the solder D8 was an inorganic solder and had composition shown in Table 22. These two materials exhibited poor chemical compatibility, significant difference in thermal physical properties, and poor wettability. To perform dissimilar material joining of the TA10 titanium alloy and the solder D8, the method was performed as followings:
1) A metal transition section 18 was designed and prepared according to composition, physical and chemical properties of the TA10 titanium alloy to be joined, where the composition of the metal transition section 18 was as shown in Table 23, and the metal transition section 18 exhibited good chemical compatibility with the TA10 titanium alloy.
2) A cladding material 18 was designed and prepared according to compositions, physical and chemical properties of the metal transition section 18 and the solder D8, where the cladding material R8 was a welding wire, the composition of which was shown in Table 24, the cladding material R8 exhibited good plasticity, as well as good chemical compatibility with the metal transition section 18 and good wettability with the solder D8.
3) A consumable electrode arc heat source was used as a cladding heat source, and consumable electrode arc welding was determined as a cladding process corresponding to the ladding heat source, process parameters for the consumable electrode arc heat source were set, a CMT mode was employed as a welding mode with inert gas protection, a consumable electrode arc heat source device was then started to locally clad a surface of the metal transition section 18 by using the cladding material R8 to prepare a cladding layer 28, thus forming a bimetallic layer L8 composed of the cladding layer 28 and the metal transition section 18.
4) A surface of the cladding layer 28 was polished, and the bimetallic layer L8 was stamped from one surface of the cladding layer 28 by a stamping device, to make the bimetallic layer L8 form a depression as well as a stamped hole 38 at a center, thus preparing a stamped bimetallic structural part W8.
5) A non-consumable electrode aro heat source was used as a joining heat source, a non-consumable electrode arc welding was determined as a joining process corresponding to the joining heat source, process parameters for the non-consumable electrode are heat source were set, inert gas protection was employed, the joining mode was a butt joint, and a non-consumable electrode arc heat source device was started, and the TA10 titanium alloy with the metal transition section 18 in the stamped bimetallic structural part W8 were joined to prepare a dissimilar material structural component S8 for vacuum sealing.
6) The dissimilar material structural component S8 for vacuum sealing was joined with other parts of a vessel by welding to form a vessel V8.
7) The solder D8 was placed at the stamped hole 38 formed by stamping the bimetallic layer of the vessel V8, then the vessel V8 was placed in a vacuum furnace, process parameters were set, and the vacuum furnace was started to perform vacuum sealing between the solder D8 and the vessel V8, thereby preparing a vacuum vessel.

TABLE 22
Composition and content of solder D8

| Material | Composition and content (wt %) | | | | | | |
|---|---|---|---|---|---|---|---|
| name | SiO₂ | BaO | Al₂O₃ | Li₂O | ZnO | P₂O₅ | B₂O₃ |
| Solder D8 | 58 | 26 | 3 | 7 | 1 | 2.5 | 2.5 |

TABLE 23
Composition and content of metal transition section 18

| | Composition and content (wt %) | | | | | | | | | |
|---|---|---|---|---|---|---|---|---|---|---|
| Material name | Nb | Ti | Fe | C | Ta | Ni | Zr | W | Mo | Cr |
| Metal transition | 94.98 | | | 0.02 | 0.5 | | 1.4 | 1.5 | 1.6 | |
| section 18 | | | | | | | | | | |

TABLE 24
Composition and content of cladding material R8

| | Composition and content (wt %) | | | | |
|---|---|---|---|---|---|
| Material name | Cu | Sn | P | Fe | Pb |
| Cladding material R8 | 99.77 | 0.15 | 0.01 | 0.05 | 0.02 |

### Example 9

In a method for joining dissimilar materials of a titanium metal and a solder for vacuum vessel sealing, the joining materials were TA15 titanium alloy and solder D9, where the solder D9 was an inorganic solder and had composition shown in Table 25. These two materials exhibited poor chemical compatibility, significant difference in thermal physical properties, and poor wettability. To perform dissimilar material joining of the TAIS titanium alloy and the solder D9, the method was perform as follows:
1) A metal transition section 19 was designed and prepared according to composition, physical and chemical properties of the TA15 titanium alloy to be joined, where the composition of the metal transition section 19 was as shown in Table 26, and the metal transition section 19 exhibited good chemical compatibility with the TAIS titanium alloy.
2) A cladding material R9 was designed and prepared according to the compositions, physical and chemical properties of the metal transition section 19 and the solder D9, where the cladding material R9 was a powder, the composition of which was shown in Table 27, the cladding material R9 exhibited good plasticity, as well as good chemical compatibility with the metal transition section 19 and good wettability with the solder D9.
3) A laser heat source was used as a cladding heat source, and powder feeding laser cladding was determined as a cladding process corresponding to the ladding heat source, process parameters for the laser heat source were set, inert gas protection was employed, and a laser heat source device was then started to locally clad a surface of the metal transition section 19 by using the cladding material R9 to prepare a cladding layer 29, thus forming a bimetallic layer L9 composed of the cladding layer 29 and the metal transition section 19.
4) A surface of the cladding layer 29 was polished, and the bimetallic layer L9 was stamped from one surface of the cladding layer 29 by using a stamping device, to make the bimetallic layer L9 form a depression as well as a stamped hole 39 at a center, thus preparing a stamped bimetallic structural part W9.
5) A consumable electrode arc heat source was used as a joining heat source, consumable electrode arc welding was determined as a joining process corresponding to the joining heat source, process parameters for the consumable electrode arc heat source were set, a direct current mode was employed as a welding mode with inert gas protection, and the composition of a welding wire H9 was as shown in Table 26, where the welding wire H9 exhibited good chemical compatibility with the TA15 titanium alloy and the metal transition section 19, the joining mode was a lap joint, and a consumable electrode are heat source device was started, and the TAIS titanium alloy with the metal transition section 19 in the stamped bimetallic structural part W9 were joined to prepare a dissimilar material structural component S9 for vacuum sealing.
6) The dissimilar material structural component S9 for vacuum sealing was joined with other parts of a vessel by welding to form a vessel V9.
7) The solder D9 was placed at the stamped hole 39 formed by stamping the bimetallic layer of the vessel V9, then the vessel V9 was placed in a vacuum furnace, process parameters were set, and the vacuum furnace was started to perform vacuum sealing between the solder D9 and the vessel V9, thereby preparing a vacuum vessel.

TABLE 25
Composition and content of solder D9

| Material | Composition and content (wt %) | | | | | | |
|---|---|---|---|---|---|---|---|
| name | ZnO | B₂O₃ | SiO₂ | Li₂O | Al₂O₃ | CaF₂ | TiO₂ |
| Solder D9 | 52 | 19 | 10 | 3 | 3 | 12 | 1 |

TABLE 26
Compositions and contents of metal transition section 19 and welding wire H9

| | Composition and content (wt %) | | | | | | | | | |
|---|---|---|---|---|---|---|---|---|---|---|
| Material name | V | Ti | Fe | C | Ta | Ni | Zr | W | Mo | Al |
| Metal transition | 99.6 | 0.05 | 0.04 | 0.05 | 0.05 | 0.05 | 0.05 | 0.1 | 0.01 | |
| section 19 | | | | | | | | | | |
| Welding wire H9 | 1.2 | 90.2 | | 0.05 | 0.05 | | 2.0 | | 1.0 | 5.5 |

TABLE 27
Composition and content of cladding material R9

| Material | Composition and content (wt %) | | | | | | | |
|---|---|---|---|---|---|---|---|---|
| name | Cu | P | Bi | Fe | Ni | Sn | Zn | Ag |
| Cladding | 99.96 | 0.002 | 0.001 | 0.005 | 0.003 | 0.022 | 0.005 | 0.002 |
| material R9 | | | | | | | | |

### Example 10

In a method for joining dissimilar materials of a titanium metal and a solder for vacuum vessel sealing, the joining materials were TA18 titanium alloy and solder D10, where the solder D10 was an inorganic solder and had composition shown in Table 28. These two materials exhibited poor chemical compatibility, significant difference in thermal physical properties, and poor wettability. To perform dissimilar material joining of the TA18 titanium alloy and the solder D10, the method was perform as follows:
1) A metal transition section 110 was designed and prepared according to composition, physical and chemical properties of the TA18 titanium alloy to be joined, where the composition of the metal transition section 110 was as shown in Table 29, and the metal transition section 110 exhibited good chemical compatibility with the TA18 titanium alloy.
2) A cladding material R10 was designed and prepared according to compositions, physical and chemical properties of the metal transition section 110 and the solder D10, where the cladding material R10 was a welding wire, the composition of which was shown in Table 30, the cladding material R10 exhibited good plasticity, as well as good chemical compatibility with the metal transition section 110 and good wettability with the solder D10.
3) A laser-arc hybrid heat source was used as a cladding heat source, and laser-consumable electrode are hybrid welding was determined as a cladding process corresponding to the ladding heat source, process parameters for the laser-arc hybrid heat source were set, inert gas protection was employed, and a laser-arc hybrid heat source device was then started to locally clad a surface of the metal transition section 110 by using the cladding material R10 to prepare a cladding layer 210, thus forming a bimetallic layer L10 composed of the cladding layer 210 and the metal transition section 110.
4) A surface of the cladding layer 210 was polished, and the bimetallic layer L10 was stamped from one surface of the cladding layer 210 by using a stamping device, to make the bimetallic layer L10 form a depression as well as a stamped hole 310 at a center, thus preparing a stamped bimetallic structural part W10.
5) A plasma are heat source was used as a joining heat source, plasma welding with filler wire was determined as a joining process corresponding to the joining heat source, process parameters for the plasma arc heat source were set, inert gas protection was employed, and the composition of a welding wire H10 was as shown in Table 29, where the welding wire H10 exhibited good chemical compatibility with the TA18 titanium alloy and the metal transition section 110, the joining mode was a lap joint, and a plasma arc heat source device was started, and the TA18 titanium alloy with the metal transition section 110 in the stamped bimetallic structural part W10 were joined to prepare a dissimilar material structural component S10 for vacuum sealing.
6) The dissimilar material structural component S10 for vacuum sealing was joined with other parts of a vessel by welding to form a vessel V10.
7) The solder D10 was placed at the stamped hole 310 formed by stamping the bimetallic layer of the vessel V10, then the vessel V10 was placed in a vacuum furnace, process parameters were set, and the vacuum furnace was started to perform vacuum sealing between the solder D10 and the vessel V10, thereby preparing a vacuum vessel.

TABLE 28
Composition and content of solder D10

| Material | Composition and content (wt %) | | | | | | | | |
|---|---|---|---|---|---|---|---|---|---|
| name | SiO₂ | Al₂O₃ | K₂O | B₂O₃ | Na₂O | CaF₂ | BaO | Li₂O | SrO |
| Solder D10 | 63 | 3 | 8 | 2 | 3 | 9 | 2 | 5 | 5 |

TABLE 29
Compositions and contents of metal transition section 310 and welding wire H10

| | Composition and content (wt %) | | | | | | | | | |
|---|---|---|---|---|---|---|---|---|---|---|
| Material name | V | Ti | Cr | C | Nb | Ni | Zr | Ta | Mo | Al |
| Metal transition | 95.85 | 2.5 | | 0.05 | 0.5 | | 0.05 | 0.6 | 0.4 | 0.05 |
| section 310 | | | | | | | | | | |
| Welding wire H10 | 98.15 | 1.2 | 0.05 | 0.05 | | 0.05 | | 0.48 | | 0.02 |

TABLE 30
Composition and content of cladding material R10

| | Composition and content (wt %) | | | | | | | |
|---|---|---|---|---|---|---|---|---|
| Material name | Cu | P | Si | Fe | Mn | Sa | Zn | Al |
| Cladding | 97.14 | 0.02 | 1.6 | 0.08 | 0.7 | 0.25 | 0.2 | 0.01 |
| material R10 | | | | | | | | |

### Example 11

In a method for joining dissimilar materials of a titanium metal and a solder for vacuum vessel sealing, the joining materials were TC4 titanium alloy and solder D11, where the solder D11 was a metal solder and had composition shown in Table 31. These two materials exhibited poor chemical compatibility, significant difference in thermal physical properties, and poor wettability. To perform dissimilar material joining of the TC4 titanium alloy and the solder D11, the method was perform as follows:
1) A metal transition section 111 was designed and prepared according to composition, physical and chemical properties of the TC4 titanium alloy to be joined, where the composition of the metal transition section 111 was as shown in Table 32, and the metal transition section 111 exhibited good chemical compatibility with the TC4 titanium alloy.
2) A cladding material R11 was designed and prepared according to compositions, physical and chemical properties of the metal transition section 111 and the solder D11, where the cladding material R11 was a welding wire, the composition of which was shown in Table 33, the cladding material R11 exhibited good plasticity, as well as good chemical compatibility with the metal transition section 111 and good wettability with the solder D11.
3) A laser heat source was used as a cladding heat source, laser welding with filler wire was determined as a cladding process corresponding to the ladding heat source, process parameters for the laser heat source were set, inert gas protection was employed, and a laser heat source device was then started to locally clad a surface of the metal transition section 111 by using the cladding material R11 to prepare a cladding layer 211, thus forming a bimetallic layer L11 composed of the cladding layer 211 and the metal transition section 111.
4) A surface of the cladding layer 211 was polished, and the bimetallic layer L11 was stamped from one surface of the cladding layer 211 by using a stamping device, to make the bimetallic layer L11 form a depression as well as a stamped hole 311 at a center, thus preparing a stamped bimetallic structural part W11.
5) A consumable electrode arc heat source was used as a joining heat source, consumable electrode arc welding was determined as a joining process corresponding to the joining heat source, process parameters for the consumable electrode are heat source were set, an alternating current mode was employed as a welding mode with inert gas protection, and the composition of a welding wire H11 was as shown in Table 32, where the welding wire H11 exhibited good chemical compatibility with the TC4 titanium alloy and the metal transition section 111, the joining mode was a butt joint, and a consumable electrode are heat source device was started, and the TC4 titanium alloy with the metal transition section 111 in the stamped bimetallic structural part W11 were join to prepare a dissimilar material structural component S11 for vacuum sealing.
6) The dissimilar material structural component S11 for vacuum sealing was joined with other parts of a vessel by welding to form a vessel V11.
7) The solder D11 was placed at the stamped hole 311 formed by stamping the bimetallic layer of the vessel V11, then the vessel V11 was placed in a vacuum furnace, process parameters were set, and the vacuum furnace was started to perform vacuum sealing between the solder D11 and the vessel V11, thereby preparing a vacuum vessel.

TABLE 31
Composition and content of solder D11

Composition and content (wt %)

| Material name | Ag | Cu | In | Ti |
|---|---|---|---|---|
| Solder D11 | 66 | 19 | 12 | 3 |

TABLE 32
Compositions and contents of metal transition section 111 and welding wire H11

| | Composition and content (wt %) | | | | | | | | | |
|---|---|---|---|---|---|---|---|---|---|---|
| Material name | V | Ti | Cr | W | Nb | Mo | Zr | Si | C | Ta |
| Metal transition | 99.59 | 0.01 | | 0.12 | 0.04 | 0.01 | 0.2 | | 0.02 | 0.01 |
| section 111 | | | | | | | | | | |
| Welding wire H11 | 95.74 | 0.04 | 0.05 | 0.15 | 2.1 | 1.7 | | 0.2 | | 0.02 |

TABLE 33
Composition and content of cladding material R11

| Material | Composition and content (wt %) | | | | | | |
|---|---|---|---|---|---|---|---|
| name | Cu | P | Bi | Fe | Ni | Sn | Zn |
| Cladding | 99.98 | 0.001 | 0.002 | 0.005 | 0.004 | 0.002 | 0.006 |
| material R11 | | | | | | | |

### Example 12

In a method for joining dissimilar materials of a titanium metal and a solder for vacuum vessel sealing, the joining materials were TB2 titanium alloy and solder D12, where the solder D12 was a metal solder and had composition shown in Table 34. These two materials exhibited poor chemical compatibility, significant difference in thermal physical properties, and poor wettability. To perform dissimilar material joining of the TB2 titanium alloy and the solder D12, the method was performed as follows:
1) A metal transition section 112 was designed and prepared according to composition, physical and chemical properties of the TB2 titanium alloy to be joined, where composition of the metal transition section 112 was as shown in Table 35, and the metal transition section 112 exhibited good chemical compatibility with the TB2 titanium alloy.
2) A cladding material R12 was designed and prepared according to compositions, physical and chemical properties of the metal transition section 112 and the solder D12, where the cladding material R12 was a powder, the composition of which was shown in Table 36, the cladding material R12 exhibited good plasticity, as well as good chemical compatibility with the metal transition section 112 and good wettability with the solder D12.
3) A laser heat source was used as a cladding heat source, and powder feeding laser cladding was determined as a cladding process corresponding to the ladding heat source, process parameters for the laser heat source were set, inert gas protection was employed, and a laser heat source device was then started to locally clad a surface of the metal transition section 112 by using the cladding material R12 to prepare a cladding layer 212, thus forming a bimetallic layer L12 composed of the cladding layer 212 and the metal transition section 112.
4) A surface of the cladding layer 212 was polished, and the bimetallic layer L12 was stamped from one surface of the cladding layer 212 by using a stamping device, to make the bimetallic layer L12 form a depression as well as a stamped hole 312 at a center, thus preparing a stamped bimetallic structural part W12.
5) A laser-arc hybrid heat source was used as a joining heat source, laser-consumable electrode are hybrid welding was determined as a joining process corresponding to the joining heat source, process parameters for the laser—are hybrid heat source were set, inert gas protection was employed, and the composition of a welding wire H12 was as shown in Table 35, where the welding wire H12 exhibited good chemical compatibility with the TB2 titanium alloy and the metal transition section 112, the joining mode was a lap joint, and a laser-arc hybrid heat source device was started, and the TB2 titanium alloy with the metal transition section 112 in the stamped bimetallic structural part W12 were joined to prepare a dissimilar material structural component S12 for vacuum sealing.
6) The dissimilar material structural component S12 for vacuum sealing was joined with other parts of a vessel by welding to form a vessel V12.
7) The solder D12 was placed at the stamped hole 312 formed by stamping the bimetallic layer of the vessel V12, then the vessel V12 was placed in a vacuum furnace, process parameters were set, and the vacuum furnace was started to perform vacuum sealing between the solder D12 and the vessel V12, thereby preparing a vacuum vessel.

TABLE 34
Composition and content of solder D12

Composition and content (wt %)

| Material name | Cu | Ag | In |
|---|---|---|---|
| Solder D12 | 27 | 63 | 10 |

TABLE 35
Compositions and contents of metal transition section 112 and welding wire H12

| | Composition and content (wt %) | | | | | | | | | |
|---|---|---|---|---|---|---|---|---|---|---|
| Material name | Nb | V | Cr | W | Ti | Mo | Zr | Si | C | Ta |
| Metal transition | 97.45 | 0.05 | | | 0.7 | 1.7 | 0.03 | | 0.05 | 0.02 |
| section 112 | | | | | | | | | | |
| Welding wire H12 | 0.2 | 99.05 | 0.05 | 0.5 | 0.15 | | | 0.02 | 0.03 | |

TABLE 36
Composition and content of cladding material R12

| | Composition and content (wt %) | | | | | | | |
|---|---|---|---|---|---|---|---|---|
| Material name | Cu | P | Ag | Bi | Fe | Ni | Sn | Zn |
| Cladding | 99.64 | 0.002 | 0.346 | 0.001 | 0.004 | 0.002 | 0.002 | 0.003 |
| material R12 | | | | | | | | |

An additive manufacturing technology (surface modification technology), a dissimilar metal joining technology, and a dissimilar material brazing technology are organically combined in the above embodiments. An appropriate metal transition section is designed and employed according to the composition, physical and chemical properties of the titanium metal and the solder. Then, an appropriate cladding material is designed and employed, and an appropriate cladding heat source and a corresponding cladding process are used to achieve high-quality cladding on the surface of the metal transition section, Next, an appropriate joining heat source and a corresponding joining process are used for high-quality joining between the titanium metal and the metal transition section by employing an appropriate welding wire or not employing the welding wire. Finally, high-quality brazing sealing between the cladding layer and the solder is achieved, enabling high-quality indirect joining between the titanium metal and the solder. This method addresses the problems of large stress and deformation, susceptibility to brittle structure formation, poor internal quality of the joint, low bonding strength, poor impact resistance, inadequate thermal insulation performance, poor sealing performance, and short service life of the vessel. These problems are caused by significant difference in physical properties, poor chemical compatibility, and poor wettability between the titanium metal and the solder for vacuum vessel scaling. The dissimilar material joining method has several advantages, including low joining cost, a simple joining process, high joining efficiency, good welding flexibility, and small stress and deformation. The method also prevents grain coarsening in the heat-affected zone, avoids the formation of brittle structures at the cladding interface and a fusion welding joint, and eliminates various joining defects. The internal quality of the cladding layer and the fusion weld is excellent, and the bonding strength at the cladding interface and the fusion welding joint is high. Additionally, the brazing sealing joint exhibits high bonding strength and excellent sealing performance. The combined joint of the titanium metal and the solder exhibits excellent internal quality and high bonding strength, superior impact resistance, thermal insulation efficiency, and sealing performance, making the vessel have long service life.

The above is only the preferred embodiment of the present disclosure, and is not intended to limit the present disclosure. Any modification, equivalent substitution, improvement, etc, made within the spirit and principle of the present disclosure should fall within the scope of the present disclosure.

1. A method for joining dissimilar materials of a titanium metal and a solder for vacuum vessel sealing, comprising the following steps:
1) designing and preparing a metal transition section (1) according to composition, physical and chemical properties of a titanium metal (4) to be joined, wherein the metal transition section (1) is required to exhibit good chemical compatibility with the titanium metal (4);
2) designing and preparing a cladding material R according to compositions, physical and chemical properties of the metal transition section (1) and a solder D, wherein the cladding material R is required to exhibit good plasticity, as well as good chemical compatibility with the metal transition section (1) and good wettability with the solder D;
3) selecting a cladding heat source and determining a cladding process corresponding to the cladding heat source, setting process parameters for the cladding heat source, starting a first heat source device, and locally cladding a surface of the metal transition section (1) by using the cladding material R to prepare a cladding layer (2), thereby forming a bimetallic layer L composed of the cladding layer (2) and the metal transition section (1);
4) polishing a surface of the cladding layer (2), and stamping the bimetallic layer L from one surface of the cladding layer (2) by using a stamping device, to make the bimetallic layer L form a depression as well as a stamped hole (3) at a center, thus preparing a stamped bimetallic structural part W;
5) selecting a joining heat source and determining a joining process corresponding to the joining heat source, setting process parameters for the joining heat source, starting a second heat source device, and joining the titanium metal (4) and the metal transition section (1) in the stamped bimetallic structural part W to prepare a dissimilar material structural component S for vacuum sealing;
6) joining the dissimilar material structural component S for vacuum sealing with other parts of a vessel by welding to form a vessel V; and
7) placing the solder D at the stamped hole formed by stamping the bimetallic layer of the vessel V, then placing the vessel V in a vacuum furnace, setting process parameters, and starting the vacuum furnace to perform vacuum sealing between the solder D and the vessel V, thereby preparing a vacuum vessel.

2. The method of claim 1, wherein the titanium metal (4) comprises pure titanium or a titanium alloy; the solder D comprises a metal solder or an inorganic solder; and the cladding material R comprises a form of a welding wire or a powder.

3. The method of claim 2, wherein the pure titanium comprises one selected from the group consisting of TA1 pure titanium, TA2 pure titanium, TA3 pure titanium, TA1G pure titanium, TA2G pure titanium, TA3G pure titanium, and TA4G pure titanium.

4. The method of claim 2, wherein the titanium alloy comprises one selected from the group consisting of TA10 titanium alloy, TA15 titanium alloy, TA18 titanium alloy, TC4 titanium alloy, and TB2 titanium alloy.

5. The method of claim 2, wherein the inorganic solder comprises one selected from the group consisting of an oxide and a fluoride.

6. The method of claim 1, wherein joining the titanium metal (4) and the metal transition section (1) in the stamped bimetallic structural part W is conducted by using a butt joint or a lap joint.

7. The method of claim 1, wherein the cladding heat source comprises one selected from the group consisting of a consumable electrode arc heat source, a non-consumable electrode arc heat source, a plasma arc heat source, a laser heat source, and a laser-arc hybrid heat source.

8. The method of claim 7, wherein the consumable electrode arc heat source, the non-consumable electrode arc heat source, the plasma arc heat source, the laser heat source, and the laser-arc hybrid heat source each are used for cladding under inert gas protection.

9. The method of claim 7, wherein the cladding process corresponding to the consumable electrode arc heat source is consumable electrode arc welding; the cladding process corresponding to the non-consumable electrode arc heat source is non-consumable electrode arc welding with filler wire; the cladding process corresponding to the plasma arc heat source is plasma spray welding or plasma welding with filler wire; the cladding process corresponding to the laser heat source is laser welding with filler wire or powder feeding laser cladding; and the cladding process corresponding to the laser-arc hybrid heat source is laser-consumable electrode arc hybrid welding.

10. The method of claim 1, wherein the joining heat source comprises one selected from the group consisting of a consumable electrode arc heat source, a non-consumable electrode arc heat source, a plasma arc heat source, an electron beam heat source, a laser heat source, and a laser-arc hybrid heat source.

11. The method of claim 10, wherein the consumable electrode arc heat source, the non-consumable electrode arc heat source, the plasma arc heat source, the laser heat source, and the laser-arc hybrid heat source each are used for joining under inert gas protection, and the electron beam heat source is used for joining under a vacuum condition.

12. The method of claim 10, wherein the joining process corresponding to the consumable electrode arc heat source is consumable electrode arc welding; the joining process corresponding to the non-consumable electrode arc heat source is non-consumable electrode arc welding or non-consumable electrode arc welding with filler wire; the joining process corresponding to the plasma arc heat source is plasma spray welding or plasma welding with filler wire; the joining process corresponding to the electron beam heat source is vacuum electron beam welding; the joining process corresponding to the laser heat source is pure laser welding or laser welding with filler wire; and the joining process corresponding to the laser-arc hybrid heat source is laser-consumable electrode arc hybrid welding.

13. The method of claim 12, wherein a welding material for the consumable electrode arc welding, the non-consumable electrode arc welding with filler wire, the plasma welding with filler wire, the laser welding with filler wire, or the laser-consumable electrode arc hybrid welding is a welding wire H, and the welding wire H is required to exhibit good chemical compatibility with both the titanium metal (4) and the metal transition section (1).

14. The method of claim 9, wherein a welding mode for the consumable electrode arc welding is one selected from the group consisting of a CMT (cold metal transfer) mode, a pulse mode, a direct current mode, and an alternating current mode.

15. The method of claim 12, wherein a welding mode for the non-consumable electrode arc welding is one selected from the group consisting of a pulse mode, a direct current mode, and an alternating current mode.

16. A dissimilar material structural component for vacuum sealing, being formed by joining a stamped bimetallic structural part W and a titanium metal (4); wherein
the stamped bimetallic structural part W is formed by stamping a bimetallic layer L, the stamping comprises stamping from one surface of a cladding layer (2) of the bimetallic layer L to make the bimetallic layer L form a depression as well as a stamped hole (3) at a center;
the bimetallic layer L is composed of the cladding layer (2) and a metal transition section (1), and the cladding layer (2) is prepared by locally cladding a surface of the metal transition section (1) by using a cladding material R;
a material for the metal transition section (1) exhibits good chemical compatibility with that of the titanium metal (4); and
a material for the cladding layer (2) exhibits good plasticity, and good chemical compatibility with that of the metal transition section (1).

17. The dissimilar material structural component of claim 16, wherein the Joining is conducted by using a butt joint or a lap joint;
under a condition that the joining is conducted by using the butt joint, the dissimilar material structural component further comprises a butt weld (5); and
under a condition that the joining is conducted by using the lap joint, the dissimilar material structural component further comprises a lap weld (6).

18. A method for preparing the dissimilar material structural component of claim 16, comprising the following steps:
1) designing and preparing the metal transition section (1) according to composition, physical and chemical properties of the titanium metal (4) to be joined, wherein the metal transition section (1) is required to exhibit good chemical compatibility with the titanium metal (4);
2) designing and preparing the cladding material R according to compositions, physical and chemical properties of the metal transition section (1) and a solder D, wherein the cladding material R is required to exhibit good plasticity, as well as good chemical compatibility with the metal transition section (1) and good wettability with the solder D;
3) selecting a cladding heat source and determining a cladding process corresponding to the cladding heat source, setting process parameters for the cladding heat source, starting a first heat source device, and locally cladding a surface of the metal transition section (1) by using the cladding material R to prepare the cladding layer (2), thereby forming the bimetallic layer L composed of the cladding layer (2) and the metal transition section (1);
4) polishing a surface of the cladding layer (2), and stamping the bimetallic layer L from one surface of the cladding layer (2) by using a stamping device, to make the bimetallic layer L form a depression as well as a stamped hole (3) at a center, thereby preparing the stamped bimetallic structural part W; and
5) selecting a joining heat source and determining a joining process corresponding to the joining heat source, setting process parameters for the joining heat source, starting a second heat source device, and joining the titanium metal (4) and the metal transition section (1) in the stamped bimetallic structural part W to prepare the dissimilar material structural component for vacuum sealing.
